(19) United States
(12) Patent Application Publication
(10) Pub. No.: US 2016/0053209 A1
(43) Pub. Date: Feb. 25, 2016

(54) Stator/rotor mixing process for the production of laundry detergent paste

(71) Applicant: Reckitt Benckiser N.V., WT Hoofddorp (NL)

(72) Inventors: Roberto Casonati, Mira (IT); Igor DABALA, Mira (IT); Umberto TONIOLO, Mira (IT); Giuseppe DI BONO, Dolo (IT); Ralf Wiedemann, Sao Paulo CEP (BR)

(21) Appl. No.: 14/379,126

(22) PCT Filed: Feb. 22, 2013
(86) PCT No.: PCT/GB2013/050440

§ 371 Date: Aug. 15, 2014

(30) Foreign Application Priority Data
Feb. 22, 2012 (GB) 1203000.3

(51) Int. Cl. C11D 11/00; C11D 17/00

(52) U.S. Cl. CPC C11D 11/0094; C11D 17/003

(57) ABSTRACT

A process of producing a paste-form, detergent composition comprises admixing/mixing a particulate detergent composition with a liquid.

This invention relates to a process for the production of paste-form detergents and cleaning compositions (and to devices used for preparing same).

Paste-form detergents and cleaning compositions, hereinafter referred to as detergents, have advantages insofar as they are easy to handle and, in terms of equipment, are relatively easy to produce, another advantage being that their ingredients may be selected from a relatively broad range so that their composition may largely be adapted to meet specific washing requirements.

Pastes are particularly useful in the pre-treatment of stains (e.g. on fabric/clothing) as they can be easily applied to stains (in comparison to, for example, solid/powder formulations.

Paste-form detergents differ from liquid detergents (and powder/solid detergent) which, unless suitable measures are taken, show unwanted sedimentation which detrimentally affects their performance and convenience. In addition, where active oxygen compounds are part of the formulation, liquid detergents also generally undergo an unacceptable degradation of active oxygen. Also pastes have certain limitations in formulation and, for example, can not comprise bleach and enzymes at the same time, when water based.

Furthermore there is a two-fold problem in that pastes can be expensive and complex to prepare/package by a manufacturer yet if the paste preparation is left to an end user this can be problematic since the end user is exposed to potentially harmful chemicals in the paste preparation process.

It is an object of the present invention to obviate and/or mitigate the problems outlined above.

According to a first aspect of the invention there is provided a process of producing a paste-form, detergent composition comprising admixing/mixing a particulate detergent composition with a liquid.

Preferably said admixing/mixing of said detergent composition comprises the use of a stator/rotor mixing unit. Thus according to a second aspect of the invention there is provided a stator/rotor mixing unit for use in a process of producing a paste-form, detergent composition comprising admixing/mixing a particulate detergent composition with a liquid.

It will be appreciated that any features of the first aspect of the invention shall be taken to apply to the second aspect of the invention mutatis mutandis.

By the use of the stator/rotor mixing unit it has been found that a paste form detergent can be prepared by an end user wherein the process of preparation, the end product and its application all show excellent properties. Namely from the production perspective the process is able to yield a stable product wherein the process precludes the use of expensive and complex manufacturing techniques and convoluted packaging. Additionally with the stator/rotor mixing unit it has been found that a consumer is protected from (over) exposure to any harmful chemicals in the detergent product.

Furthermore it has been found that with the use of the stator/rotor mixing unit it is straightforward for a consumer to avoid skin contact with the detergent material (as part of the mixing device can be used to transfer the created paste to the garment/stain—no further element is necessarily required). Additionally it has been observed that the in-situ formation of a paste and transfer of same allows the formation of a highly effective detergent/stain treatment formulation.

Preferably the detergent is a pre-treatment formulation intended to be applied to a portion of a garment/fabric before a more intensive washing process. As such it is preferred that a portion of the device may be used as an applicator of the formulated paste to apply said paste to the garment/fabric being treated. The application may include rubbing.

The cleaning composition may include a viscosity modifier, e.g., a thickener which can be used to modify, e.g. increase the viscosity of the cleaning composition.

Where present the viscosity modifier comprises up to 10 wt %, more preferably up to 8 wt %, more preferably up to 5 wt %, more preferably up to 3 wt %, and most preferably up to 1.5 wt % of the composition. Where present the viscosity modifier comprises more than 0.1 wt %, more preferably more than 0.3 wt %, more preferably more than 0.5 wt %, more preferably more than 0.75 wt % and most preferably more than 1 wt % of the composition.

Exemplary useful viscosity modifiers include polysaccharide polymers e.g., cellulose, alkyl celluloses, alkoxy celluloses, hydroxy alkyl celluloses, alkyl hydroxy alkyl celluloses, carboxy alkyl celluloses, carboxy alkyl hydroxy alkyl celluloses as well as other modified celluloses, naturally occurring polysaccharide polymers such as xanthan gum, carrageenan gum, guar gum, locust bean gum, tragacanth gum, or derivatives thereof, polycarboxylate polymers, polyacrylamides, clays, and mixtures thereof.

With the use of the thickeners above (particularly with the polysaccharide polymers) it has been observed that the viscosity of the paste form detergent grows with time. This has been found to be especially beneficial when the paste form detergent is used in the treatment of stains on fabric materials. Without wishing to be bound by theory it is postulated that this is due to the ability of the paste form detergent to penetrate fibres of the fabric when applied (due to its low viscosity) and then remain (resist movement out of) within the fibres of the fabric after application. The latter is assumed to allow the functional agents within the formulation to act on stains/dirt, enabling a highly efficacious treatment process. [Then its easily removed/rinsed with water after treatment]. The initial viscosity is preferably around 50-100 cP* and the final viscosity is generally above 150 cP*, more preferably above 200 cP*, more preferably above 300 cP*, more preferably above 400 cP*, more preferably above 500 cP*, more preferably above 600 cP*, more preferably above 700 cP* and most preferably above 800 cP* (*Brookfield viscometer model DVE; All measurements obtained with spindle #62 @12 rpm, 21 degrees centigrade). The time taken to change between the two viscosities is generally quite short: preferably less than 30 minutes, more preferably less than 20 minutes, more preferably less than 15 minutes, more preferably less than 10 minutes and most preferably less than 5 minutes.

Preferably the viscosity modifier comprises a naturally occurring polysaccharide polymer. Most preferably the viscosity modifier comprises a combination of xanthan gum and carrageenan gum.

The formulation preferably comprises a substance that is activated when mixed with the liquid.

Preferably there are at least 2 ingredients in the composition that when activated react with each other. Such ingredients can be a source of a peroxide (e.g. percarbonate), a bleach activator (e.g. TAED) and enzymes.

The paste may develops a gas (e.g. oxygen) as it is being formed/after formation.

Preferably the stator part of the device comprises a cup/volume that can be held by a consumer. Preferably said cup has a volume of up to 1000 cm³, more preferably in the range of 20 to 500 cm³, more preferably 20 to 200 cm³.

Preferably the rotor part of the device comprises an element capable of mixing/admixing a particulate detergent composition with a liquid. Preferred examples of these elements include a grinding surface, i.e. a surface which is preferably complementary yet smaller to the stator part of the device, wherein said surface has a raised/incised element which when the rotor/stator are moved relative to one another causing mixing/admixing of the particulate detergent composition with a liquid forming a paste. Preferably the motion comprises a rotation motion. Thus preferably the rotor and stator parts of the device generally comprise a circular shape. Usually the rotor comprises a handle for holding by a user.

Preferably the rotor and stator comprise a plastics material such as polypropylene.

According to a third aspect of the invention there is provided am method of pre-treating a garment/fabric comprising a process of producing a paste-form, detergent composition comprising admixing/mixing a particulate detergent composition with a liquid with a stator/rotor mixing unit and applying an amount of the paste produced to a garment/fabric and then washing said a garment/fabric in or with an automatic washing machine or handwashing process.

It will be understood that features of the first and second aspect of the invention shall be taken to apply to the third aspect of the invention mutatis mutandis.

Preferably the automatic washing machine comprises an automatic laundry machine. Alternatively the automatic washing machine comprises a carpet cleaning device.

Optionally the process comprises washing the device together with the garment in the laundry process.

Preferably the device reduces the particle size of the particulate detergent material by crushing granules in the mixing process.

The application of the paste may be by achieved with the use of the rotor or the paste may be poured from the stator part of the device. In a further alternative the stator may include a removable cap/lid which permits formation of the paste without leakage from the stator but then allows application of the paste through an aperture in the stator upon removal of the cap.

Generally the liquid comprises water.

Preferably the particulate detergent composition comprises a percarbonate compound in an amount of greater than 20 wt %, preferably greater than 35%.

As well as the percarbonate other bleaches may be present in the composition. Examples of bleaches that may be used are oxygen bleaches.

Peroxygen bleaching actives are: perborates, peroxides, peroxyhydrates, persulfates. A preferred compound is sodium percarbonate and especially the coated grades that have better stability. The percarbonate can be coated with silicates, borates, waxes, sodium sulfate, sodium carbonate and surfactants solid at room temperature.

Optionally, the compositions may additionally comprise from 0.01 to 30% wt, preferably from 2 to 20% wt of bleach precursors. Suitable bleach precursors are peracid precursors, i.e. compounds that upon reaction with hydrogen peroxide product peroxyacids. Examples of peracid precursors suitable for use can be found among the classes of anhydrides, amides, imides and esters such as acetyl triethyl citrate (ATC), tetra acetyl ethylene diamine (TAED), succinic or maleic anhydrides.

When a surfactant is present in the composition, it may be present in an amount of, for example, from 0.01 to 50% wt, ideally 0.1 to 30% wt and preferably 0.5 to 10% wt.

Suitable surfactants that may be employed include anionic or nonionic surfactants or mixture thereof. The nonionic surfactant is preferably a surfactant having a formula RO(CH₂CH₂O)ₙH wherein R is a mixture of linear, even carbon-number hydrocarbon chains ranging from C₁₂H₂5 to C₁₆H₃₃ and n represents the number of repeating units and is a number of from about 1 to about 12. Examples of other non-ionic surfactants include higher aliphatic primary alcohol containing about twelve to about 16 carbon atoms which are condensed with about three to thirteen moles of ethylene oxide per mole of alcohol (i.e. equivalents).

Other examples of nonionic surfactants include primary alcohol ethoxylates (available under the Neodol tradename from Shell Co.), such as C₁₁ alkanol condensed with 9 equivalents of ethylene oxide (Neodol 1-9), C₁₂₋₁₃ alkanol condensed with 6.5 equivalents ethylene oxide (Neodol 23-6.5), C₁₂₋₁₃ alkanol with 9 equivalents of ethylene oxide (Neodol 23-9), C₁₂₋₁₅ alkanol condensed with 7 or 3 equivalents ethylene oxide (Neodol 25-7 or Neodol 25-3), C₁₄₋₁₅ alkanol condensed with 13 equivalents ethylene oxide (Neodol 45-13), C₉₋₁₁ linear ethoxylated alcohol, averaging 2.5 moles of ethylene oxide per mole of alcohol (Neodol 91-2.5), and the like.

Other examples of nonionic surfactants suitable for use include ethylene oxide condensate products of secondary aliphatic alcohols containing 11 to 18 carbon atoms in a straight or branched chain configuration condensed with 5 to 30 equivalents of ethylene oxide. Examples of commercially available non-ionic detergents of the foregoing type are C₁₁₋₁₅ secondary alkanol condensed with either 9 equivalents of ethylene oxide (Tergitol 15-S-9) or 12 equivalents of ethylene oxide (Tergitol 15-S-12) marketed by Union Carbide, a subsidiary of Dow Chemical.

Octylphenoxy polyethoxyethanol type nonionic surfactants, for example, Triton X-100, as well as amine oxides can also be used as a nonionic surfactant.

Other examples of linear primary alcohol ethoxylates are available under the Tomadol tradename such as, for example, Tomadol 1-7, a C₁₁ linear primary alcohol ethoxylate with 7 equivalents EO; Tomadol 25-7, a C₁₂₋₁₅ linear primary alcohol ethoxylate with 7 equivalents EO; Tomadol 45-7, a C₁₄₋₁₅ linear primary alcohol ethoxylate with 7 equivalents EO; and Tomadol 91-6, a C₉₋₁₁ linear alcohol ethoxylate with 6 equivalents EO.

Other nonionic surfactants are amine oxides, alkyl amide oxide surfactants.

Preferred anionic surfactants are frequently provided as alkali metal salts, ammonium salts, amine salts, aminoalcohol salts or magnesium salts. Contemplated as useful are one or more sulfate or sulfonate compounds including: alkyl benzene sulfates, alkyl sulfates, alkyl ether sulfates, alkylamidoether sulfates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates. Generally, the alkyl or acyl radical in these various compounds comprise a carbon chain containing 12 to 20 carbon atoms.

Other surfactants which may be used are alkyl naphthalene sulfonates and oleoyl sarcosinates and mixtures thereof.

Any suitable soil catcher may be employed. Unlike detergents or surfactants, which simply aid in the removal of soils from surfaces, the soil catcher actively binds to the soil allowing it to be removed from the surface of the laundry. Once bound, the soil is less likely to be able to redeposit onto the surface of the laundry. Preferred soil catchers have a high affinity to both oily and water-soluble soil. Preferably, the soil catcher is a mixture of two or more soil catchers, each soil catcher may have a different affinity for different soils. Preferred soil catchers for oily soils have a non polar structure with high absorption capability. Preferred water based soil catchers are generally charged and have a high surface area in order to attract the soil by electrostatic charge and collect it.

Suitable soil catchers include polymers, such as acrylic polymers, polyesters and polyvinylpyrrolidone (PVP). The polymers may be crosslinked, examples of which include crosslinked acrylic polymers and crosslinked PVP. Super absorbing polymers are mainly acrylic polymers and they are useful for the scope of this patent.

Other important polymers are ethylidene norbene polymers, ethylidene norbene/ethylene copolymers, ethylidene norbene/propylene/ethylidene ter-polymers. Inorganic materials may also be employed. Examples include zeolites, talc, bentonites and active carbon. The latter may be used to absorb and/or degrade coloured parts of stain and/or absorb odours. Alginates, carrageneans and chitosan may also be used. Preferred water insoluble agents are selected from at least one of acrylic polymer, polyester, polyvinylpyrrolidone (PVP), silica, silicate, zeolite, talc, bentonites, active carbon, alginates, carrageneans, ethylidene morbene/propylene/ethylidene ter-polymers and chitosan in the manufacture of a detergent composition as an active agent for binding soil. Preferably the detergent composition is a laundry cleaning composition or stain-removing composition.

Preferred examples of water-insoluble soil catcher compounds comprise a solid cross-linked polyvinyl N-oxide, or chitosan product or ethylidene norbene/propylene/ethylidene ter-polymers or blend of the same, as discussed more fully hereafter.

Water soluble polymeric soil catcher agents that are suitable to be bound to insoluble carriers, or to be made insoluble via cross-linking are those polymers known in the art to inhibit the transfer of dyes from coloured fabrics onto fabrics washed therewith. These polymers have the ability to complex or adsorb the fugitive dyes washed out of dyed fabrics before the dyes have the opportunity to become attached to other articles in the wash. Especially suitable polymeric soil catcher agents are polyamine N-oxide polymers, polymers and copolymers of N-vinylpyrrolidone and N-vinylimidazole, vinyloxazolidones, vinylpyridine, vinylpyridine N-oxide, other vinylpyridine derivatives or mixtures thereof.

The soil catcher may be present in the detergent composition in an amount of 0.01 to 100% wt of the composition, preferably from 1 to 90% wt, more preferably from 5 to 50% wt.

The composition advantageously additionally comprises cleaning agents selected from the group consisting of, fillers, builders, chelating agents, activators, fragrances, enzymes or a mixture thereof. These active agents are generally water soluble, so dissolve during the wash. Thus the additional active agents are released over a period of time when exposed to water in the laundry washing machine.

Suitable fillers include bicarbonates and carbonates of metals, such as alkali metals and alkaline earth metals. Examples include sodium carbonate, sodium bicarbonate, calcium carbonate, calcium bicarbonate, magnesium carbonate, magnesium bicarbonate and sesqui-carbonates of sodium, calcium and/or magnesium. Other examples include metal carboxy glycine and metal glycine carbonate. Chlorides, such as sodium chloride; citrates; and sulfates, such as sodium sulfate, calcium sulfate and magnesium sulfate, may also be employed.

The filler may be present in an amount of 0.1 to 80% wt, preferably 1 to 60% wt.

The composition may comprise at least one builder or a combination of them, for example in an amount of from 0.01 to 80% wt, preferably from 0.1 to 50% wt. Builders may be used as chelating agents for metals, as anti-redeposition agents and/or as alkalis.

Examples of builders are described below:
the parent acids of the monomeric or oligomeric polycarboxylate chelating agents or mixtures thereof with their salts, e.g. citric acid or citrate/citric acid mixtures are also contemplated as useful builder components.
borate builders, as well as builders containing borate-forming materials than can produce borate under detergent storage or wash conditions can also be used.
iminosuccinic acid metal salts.
polyaspartic acid metal salts.
ethylene diamino tetra acetic acid and salt forms.
water-soluble phosphonate and phosphate builders are useful. Examples of phosphate builders are the alkali metal tripolyphosphates, sodium potassium and ammonium pyrophosphate, sodium and potassium and ammonium pyrophosphate, sodium and potassium orthophosphate sodium polymeta/phosphate in which the degree of polymerisation ranges from 6 to 21, and salts of phytic acid. Specific examples of water-soluble phosphate builders are the alkali metal tripolyphosphates, sodium, potassium and ammonium pyrophosphate, sodium, potassium and ammonium pyrophosphate, sodium and potassium orthophosphate, sodium polymeta/phosphate in which the degree of polymerization ranges from 6 to 21, and salts of phytic acid. Such polymers include polycarboxylates containing two carboxy groups, water-soluble salts of succinic acid, malonic acid, (ethylenedioxy)diacetic acid, maleic acid, diglycolic acid, tartaric acid, tartronic acid and fumaric acid, as well as the ether carboxylates and the sulfinyl carboxylates.

Polycarboxylates containing three carboxy groups include, in particular, water-soluble citrates, aconitrates and citraconates as well as succinate derivates such as the carboxymethloxysuccinates described in GB-A-1,379,241, lactoxysuccinates described in GB-A-1,389,732, and aminosuccinates described in NL-A-7205873, and the oxypolycarboxylate materials such as 2-oxa-1,1,3-propane tricarboxylates described in GB-A-1,387,447.

Polycarboxylate containing four carboxy groups include oxydisuccinates disclosed in GB-A-1,261,829, 1,1,2,2-ethane tetracarboxylates, 1,1,3,3-propane tetracarboxylates and 1,1,2,3-propane tetracarobyxlates. Polycarboxylates containing sulfo substituents include the sulfosuccinate derivatives disclosed in GB-A-1,398,421, GB-A-1,398,422 and U.S. Pat. No. 3,936,448, and the sulfonated pyrolysed citrates described in GB-A-1,439,000.

Alicylic and heterocyclic polycarboxylates include cyclopentane-cis,cis,cis-tetracarboxylates, cyclopentadienide pentacarboxylates, 2,3,4,5,6-hexane-hexacarboxylates and carboxymethyl derivates of polyhydric alcohols such as sorbitol, mannitol and xylitol. Aromatic polycarboxylates include mellitic acid, pyromellitic acid and the phthalic acid derivatives disclosed in GB-A-1,425,343.

Of the above, the preferred polycarboxylates are hydroxycarboxylates containing up to three carboxy groups per molecule, more particularly citrates.

Suitable polymer water-soluble compounds include the water soluble monomeric polycarboxylates, or their acid forms, homo or copolymeric polycarboxylic acids or their salts in which the polycarboxylic acid comprises at least two carboxylic radicals separated from each other by not more than two carbon atoms, carbonates, bicarbonates, borates, phosphates, and mixtures of any of the foregoing.

The carboxylate or polycarboxylate builder can be monomeric or oligomeric in type although monomeric polycarboxylates are generally preferred for reasons of cost and performance.

Suitable carboxylates containing one carboxy group include the water soluble salts of lactic acid, glycolic acid and ether derivatives thereof. Polycarboxylates containing two carboxy groups include the water-soluble salts of succinic acid, malonic acid, (ethylenedioxy)diacetic acid, maleic acid, diglycolic acid, tartaric acid, tartronic acid and fumaric acid, as well as the ether carboxylates and the sulfinyl carboxylates. Polycarboxylates containing three carboxy groups include, in particular, water-soluble citrates, aconitrates and citraconates as well as succinate derivates such as the carboxymethloxysuccinates described in GB-A-1,379,241, lactoxysuccinates described in GB-A-1,389,732, and aminosuccinates described in NL-A-7205873, and the oxypolycarboxylate materials such as 2-oxa-1,1,3-propane tricarboxylates described in GB-A-1,387,447.

Polycarboxylate containing four carboxy groups include oxydisuccinates disclosed in GB-A-1,261,829, 1,1,2,2-ethane tetracarboxylates, 1,1,3,3-propane tetracarboxylates and 1,1,2,3-propane tetracarobyxlates. Polycarboxylates containing sulfo substituents include the sulfosuccinate derivatives disclosed in GB-A-1,398,421, GB-A-1,398,422 and U.S. Pat. No. 3,936,448, and the sulfonated pyrolysed citrates described in GB-A-1,439,000.

Alicylic and heterocyclic polycarboxylates include cyclopentane-cis,cis,cis-tetracarboxylates, cyclopentadienide pentacarboxylates, 2,3,4,5,6-hexane-hexacarboxylates and carboxymethyl derivates of polyhydric alcohols such as sorbitol, mannitol and xylitol. Aromatic polycarboxylates include mellitic acid, pyromellitic acid and the phthalic acid derivatives disclosed in GB-A-1,425,343.

Of the above, the preferred polycarboxylates are hydroxycarboxylates containing up to three carboxy groups per molecule, more particularly citrates.

More preferred polymers are homopolymers, copolymers and multiple polymers of acrylic, fluorinated acrylic, sulfonated styrene, maleic anhydride, methacrylic, iso-butylene, styrene and ester monomers.

Examples of these polymers are Acusol supplied from Rohm & Haas, Syntran supplied from Interpolymer and the Versa and Alcosperse series supplied from Alco Chemical, a National Starch & Chemical Company.

The parent acids of the monomeric or oligomeric polycarboxylate chelating agents or mixtures thereof with their salts, e.g. citric acid or citrate/citric acid mixtures are also contemplated as useful builder components.

Examples of bicarbonate and carbonate builders are the alkaline earth and the alkali metal carbonates, including sodium and calcium carbonate and sesquicarbonate and mixtures thereof. Other examples of carbonate type builders are the metal carboxy glycine and metal glycine carbonates.

In the context of the present application it will be appreciated that builders are compounds that sequester metal ions associated with the hardness of water, e.g. calcium and magnesium, whereas chelating agents are compounds that sequester transition metal ions capable of catalysing the degradation of oxygen bleach systems. However, certain compounds may have the ability to do perform both functions.

Suitable chelating agents to be used herein include chelating agents selected from the group of phosphonate chelating agents, amino carboxylate chelating agents, polyfunctionally-substituted aromatic chelating agents, and further chelating agents like glycine, salicylic acid, aspartic acid, glutamic acid, malonic acid, or mixtures thereof. Chelating agents when used, are typically present herein in amounts ranging from 0.01 to 50% wt of the total composition and preferably from 0.05 to 10% wt.

Suitable phosphonate chelating agents to be used herein may include ethydronic acid as well as amino phosphonate compounds, including amino alkylene poly(alkylene phosphonate), alkali metal ethane 1-hydroxy diphosphonates, nitrilo trimethylene phosphonates, ethylene diamine tetra methylene phosphonates, and diethylene triamine penta methylene phosphonates. The phosphonate compounds may be present either in their acid form or as salts of different cations on some or all of their acid functionalities. Preferred phosphonate chelating agents to be used herein are diethylene triamine penta methylene phosphonates. Such phosphonate chelating agents are commercially available from Monsanto under the trade name DEQUEST™.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelating agent for use herein is ethylene diamine N,N′-disuccinic acid, or alkali metal, or alkaline earth, ammonium or substituted ammonium salts thereof or mixtures thereof. Ethylenediamine N,N′-disuccinic acids, especially the (S,S) isomer have been extensively described in US patent 4, 704, 233, Nov. 3, 1987, to Hartman and Perkins. Ethylenediamine N,N′-disuccinic acid is, for instance, commercially available under the tradename ssEDDS™ from Palmer Research Laboratories.

Suitable amino carboxylates to be used herein include ethylene diamine tetra acetates, diethylene triamine pentaacetates, diethylene triamine pentaacetate (DTPA), N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine diacetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS™ and methyl glycine di-acetic acid (MGDA).

The detergent compositions may comprise a solvent. Solvents can be used in amounts from 0.01 to 30% wt, preferably in amounts of 0.1 to 3% wt. The solvent constituent may include one or more alcohol, glycol, acetate, ether acetate, glycerol, polyethylene glycol with molecular weights ranging from 200 to 1000, silicones or glycol ethers. Exemplary alcohols useful in the compositions include C₂₋₈ primary and secondary alcohols which may be straight chained or branched, preferably pentanol and hexanol.

Preferred solvents are glycol ethers. Examples include those glycol ethers having the general structure Rₐ—O—[CH₂—CH(R)—(CH₂)—0]ₙ—H, wherein Rₐ is C₁₋₂₀ alkyl or alkenyl, or a cyclic alkane group of at least 6 carbon atoms, which may be fully or partially unsaturated or aromatic; n is an integer from 1 to 10, preferably from 1 to 5; and each R is selected from H or CH₃. Specific and preferred solvents are selected from propylene glycol methyl ether, dipropylene glycol methyl ether, tripropylene glycol methyl ether, propylene glycol n-propyl ether, ethylene glycol n-butyl ether, diethylene glycol n-butyl ether, diethylene glycol methyl ether, propylene glycol, ethylene glycol, isopropanol, ethanol, methanol, diethylene glycol monoethyl ether acetate, and, especially, propylene glycol phenyl ether, ethylene glycol hexyl ether and diethylene glycol hexyl ether.

The composition may, for example, comprise one enzyme or a combination of them, for example in an amount of from 0.01 to 10% wt, preferably from 0.1 to 2% wt. Enzymes in granular form are preferred. Examples of suitable enzymes are proteases, modified proteases stable in oxidisable conditions, amylases, lipases and cellulases.

Most preferably the detergent composition comprises the following admixture:—

55 wt % sodium percarbonate
20 wt % sodium bicarbonate
17 wt % sodium sulphate
4.0 wt % anionic surfactant
0.5 wt % nonionic surfactant
0.5 wt % soil catcher
0.5 wt % soil suspending polymer
0.2 wt % enzyme

### 0.5 wt % TAED

0.1 wt % fragrance.
Rest—water and minors

An alternative preferred formulation comprises the following admixture:—

45 wt % sodium percarbonate
30 wt % sodium carbonate
15 wt % sodium sulphate
1.0 wt % anionic surfactant
0.5 wt % nonionic surfactant
2 wt % silica
1.75 wt % thickener
1 wt % enzyme

### 4 wt % TAED

0.1 wt % fragrance
Rest—water and minors

The detergent composition is preferably in the form of a powder. By “powder” we mean any solid, flow able composition. Thus the powder may, for example, be in the form of granules or agglomerated particles. It may, however, be in the form of a loose agglomeration of particles. The d₅₀ particle size of the particles may range from 0.001 μm to 10 mm, preferably from 0.01 μm to 2 mm, and more preferably from 0.1 μm to 2 mm, for example 1 μm to 1 mm.

The stator/rotor mixing unit and the process of the invention is further described by reference to the following Figures in which:

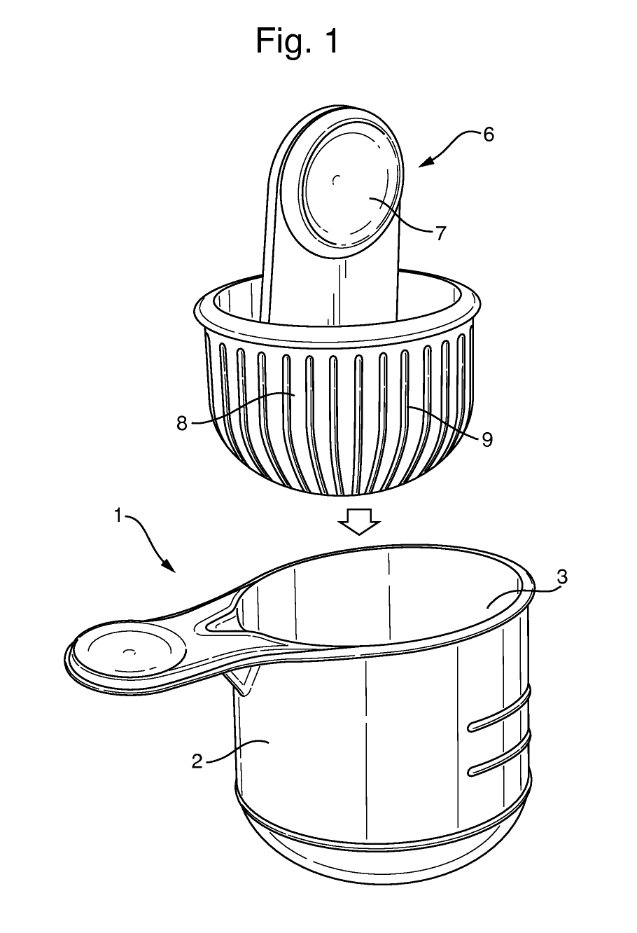

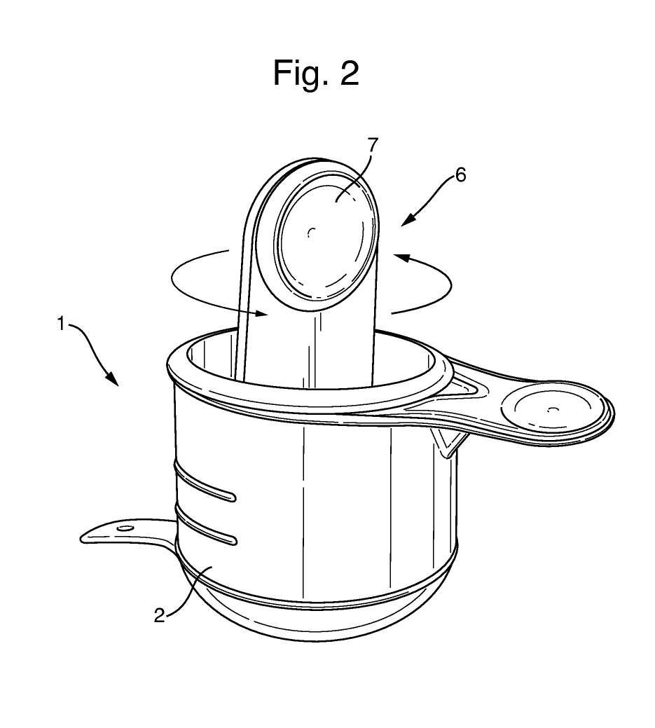

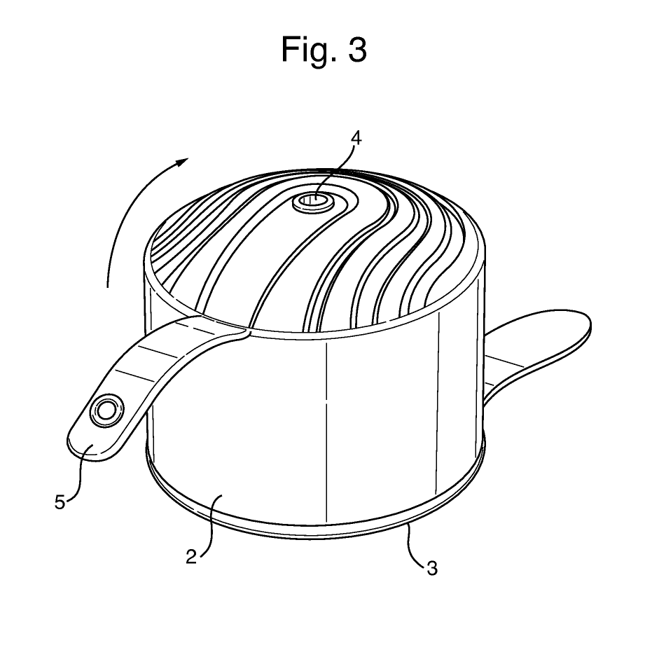

FIGS. 1 to 3 are plan view of a first embodiment of a device in accordance with the invention;

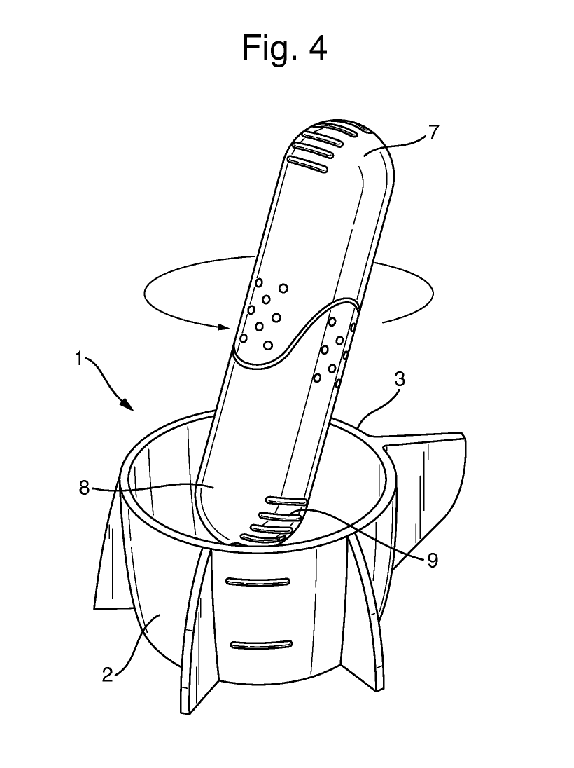

FIG. 4 is a plan view of a second embodiment of a device in accordance with the invention;

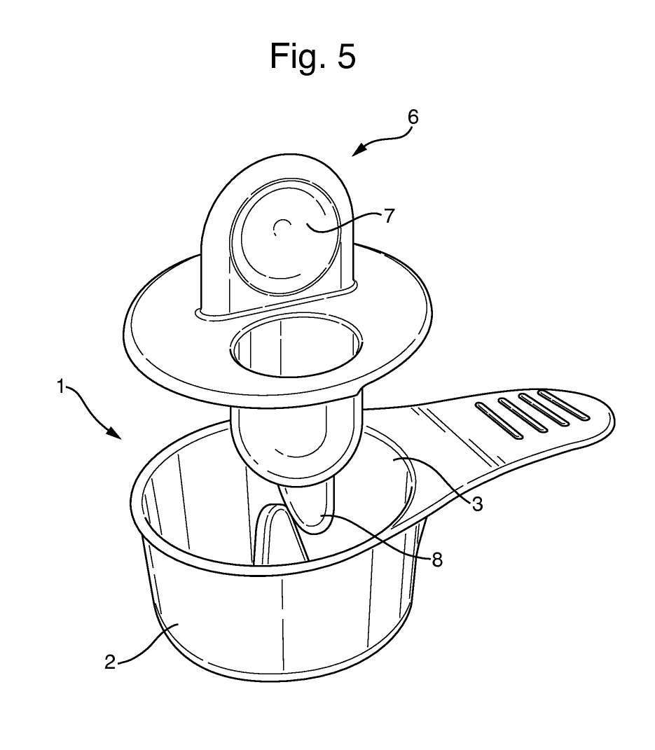

FIG. 5 is a plan view of a third embodiment of a device in accordance with the invention; and

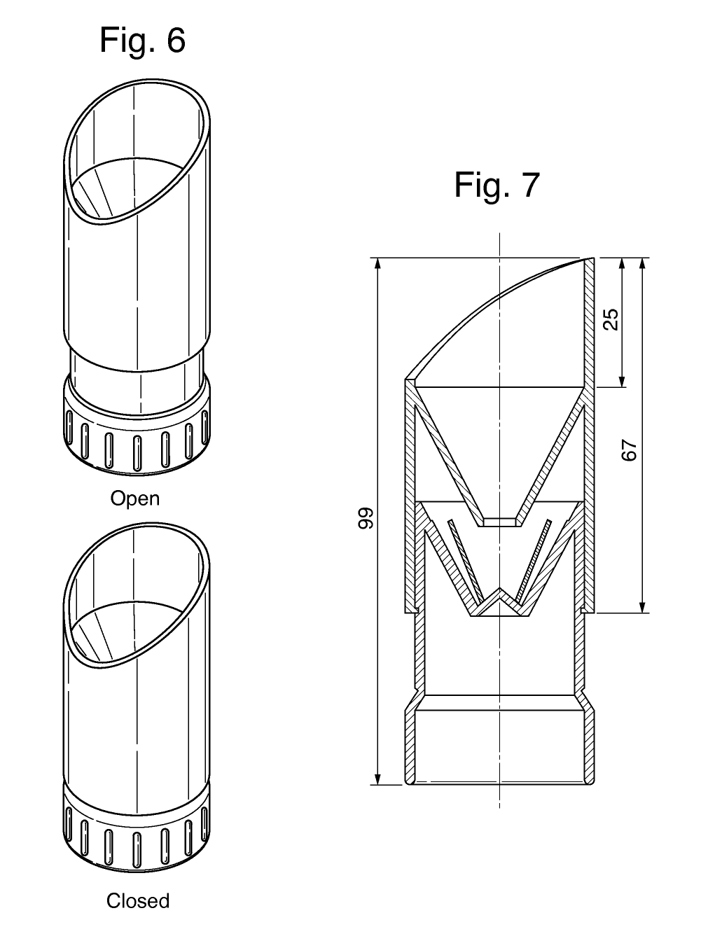

FIGS. 6 and 7 are a plan view and a cross-sectional of a fourth embodiment of a device in accordance with the invention.

From FIGS. 1 to 3 the first embodiment of a device 1 can be seen. Device 1 comprises a stator section 2 in the form of a tube with a domed end. The stator section 2 is able to act as a handle for use by a consumer. The stator section 2 has an opening 3 for introduction of particulate detergent and liquid.

The domed section of the stator 2 comprises a release aperture 4 and a cap 5.

The device further comprises a rotor section 6 comprising a rod-shaped handle 7 and a grinding surface 8. The grinding surface 8 is in the form of a dome and is complimentary to domed section of the stator 2. The grinding surface 8 comprises grinding ridges 9.

In use an amount of particulate detergent is added to the stator section 2 (with the amount added aided by the graduated markings on the side thereof). An amount of liquid is then added to the stator section 2. Insertion of the rotor section 6 follows with rotation movement thereof relative to the stator section 2, brought about by a user holding both the stator section 2 and the rotor section 6 and bringing about relative movement thereof. This causes production of a paste.

The paste may be applied to a garment/fabric being treated by use of the rotor section 6 with the stator section 2 being treated a as a reservoir, dipping the rotor section 6 therein to load it with paste as required. Alternatively dosing may be achieved by pouring from the stator 2. In a further alternative dosing may be achieved by removal of the cap/lid 5 from the stator 2 and dispensing the paste through the release aperture 4. The underside of the stator section 2, which may include ridges/incisions 10, may be used to scrub the garment/fabric being treated.

The thus pre-treated garment/fabric are placed in the drum of the washing machine, optionally together with the device 1 and optionally with other non-pre-treated fabrics. A washing cycle may then be operated. For certain fabrics/garments an alternative automatic cleaning machine, such as a carpet cleaning machine may be used.

From FIG. 4 the second embodiment of a device 1 can be seen. Device 1 comprises a stator section 2 in the form of a tube with a domed end. The stator section 2 is able to act as a handle for use by a consumer. The stator section 2 has an opening 3 for introduction of particulate detergent and liquid.

The device further comprises a rotor section 6 comprising a rod-shaped (two-piece) handle 7 and a grinding surface 8. The grinding surface 8 comprises grinding ridges 9.

The use is similar to the first embodiment.

From FIG. 5 the third embodiment of a device 1 can be seen. Device 1 comprises a stator section 2 in the form of a tube with a domed end. The stator section 2 is able to act as a handle for use by a consumer. The stator section 2 has an opening 3 for introduction of particulate detergent and liquid.

The device further comprises a rotor section 6 comprising a handle 7 and a grinding surface 8. The grinding surface 8 comprises grinding ridges 9.

The use is similar to the first embodiment.

The invention is further described with reference to the following examples.

### EXAMPLE 1

The following pulverent formulation was prepared.

| Raw Material | Wt % |
|---|---|
| Sodium Carbonate | 30 |
| Sodium Sulphate | 15 |
| Sodium Percarbonate | 45 |
| TAED G | 4 |
| Silica | 1.5 |
| Surfactant Anionic | 1.00 |
| Xanthan gum | 1.25 |
| Carrageenan Gum | 0.25 |
| Surfactant Non Ionic | 0.50 |
| Enzyme - Protease | 0.60 |
| Enzyme - Amylase | 0.15 |
| Enzyme - Lipase | 0.30 |
| Fragrance | 0.03 |

10 g of this formulation was added to 30 g of water in a glass beaker and stirred (magnetic stirrer, 6 rpm). Viscosity measurements were taken with time (Brookfeld viscometer model DVE; All measurements obtained with spindle #62 @12 rpm, 21 degrees centigrade) and are shown in the table below.

| | Viscosity | | | | |
|---|---|---|---|---|---|
| Time/ | Sample | Sample | Sample | Sample | |
| Min | 1 | 2 | 3 | 4 | Average |
| 1 | 60 | 115 | 88 | 83 | 87 |
| 3 | 104 | 203 | 125 | 128 | 140 |
| 5 | 130 | 283 | 163 | 155 | 183 |
| 7 | 150 | 380 | 225 | 213 | 242 |
| 9 | 184 | 480 | 298 | 293 | 314 |
| 11 | 210 | 540 | 358 | 343 | 363 |
| 13 | 220 | 580 | 393 | 383 | 394 |
| 15 | 230 | 613 | 425 | 438 | 427 |
| 17 | 240 | 650 | 438 | 470 | 450 |
| 19 | 240 | 675 | 450 | 490 | 464 |
| 21 | 244 | 713 | 470 | 530 | 489 |
| 23 | 247 | 728 | 495 | 540 | 503 |
| 25 | 253 | 753 | 500 | 560 | 517 |
| 27 | 260 | 773 | 505 | 563 | 525 |
| 29 | 270 | 793 | 523 | 578 | 541 |
| 31 | | | 545 | 595 | 570 |

The measurements show that the viscosity of the formulation increases with time.

1. A process of producing a paste-form, detergent composition comprising admixing and/or mixing a particulate detergent composition with a liquid.

2. A process according to claim 1, comprising the use of a stator/rotor mixing unit for use in a process of producing a paste-form, detergent composition comprising admixing and/or mixing a particulate detergent composition with a liquid.

3. A process according to claim 1, wherein the detergent comprises a laundry pre-treatment composition.

4. A process according to claim 2, wherein the stator part of the device comprises a cup and/or volume that can be held by a consumer.

5. A process according to claim 2, wherein the rotor part of the device comprises a grinding surface.

6. A stator/rotor mixing unit adapted for use in a process of producing a paste-form, detergent composition comprising admixing and/or mixing a particulate detergent composition with a liquid.

7. A method of pre-treating a garment and/or fabric comprising a process of producing a paste-form, detergent composition comprising admixing and/or mixing a particulate detergent composition with a liquid with a stator/rotor mixing unit and applying an amount of the paste produced to a garment/fabric and then washing said a garment and/or fabric in or with an automatic washing machine.

8. A method according to claim 7, wherein the automatic washing machine comprises an automatic laundry machine.

9. A process according to claim 2, wherein the detergent comprises a laundry pre-treatment composition.

10. A process according to claim 3, wherein the stator part of the device comprises a cup and/or volume that can be held by a consumer.

11. A process according to claim 4, wherein the stator part of the device comprises a cup and/or volume that can be held by a consumer.

12. A process according to claim 3, wherein the rotor part of the device comprises a grinding surface.

13. A process according to claim 4, wherein the rotor part of the device comprises a grinding surface.

14. A process according to claim 5, wherein the rotor part of the device comprises a grinding surface.
